(19) United States
(12) Patent Application Publication
(10) Pub. No.: US 2019/0140478 A1
(43) Pub. Date: May 9, 2019

(54) CAPACITOR MODULE, RESONATOR, WIRELESS POWER TRANSMISSION DEVICE, WIRELESS POWER RECEPTION DEVICE, AND WIRELESS POWER TRANSMISSION SYSTEM

(71) Applicant: TDK CORPORATION, Tokyo (JP)

(72) Inventor: Kenji FURUKAWA, Tokyo (JP)

(73) Assignee: TDK CORPORATION, Tokyo (JP)

(21) Appl. No.: 16/179,114

(22) Filed: Nov. 2, 2018

(30) Foreign Application Priority Data
Nov. 6, 2017 (JP) 2017-213478

(51) Int. Cl. H02J 50/05; H02J 5/00; H02J 7/02

(52) U.S. Cl. CPC H02J 50/05; H02J 7/025; H02J 5/005

(57) ABSTRACT

A capacitor module allows a current to equally flow through a plurality of capacitor elements mounted on a substrate having a first wiring that electrically connects the elements, which are adjacent to one another in a first direction among a plurality of elements constituting a element array, to one another, a second wiring that electrically connects the elements, which are positioned at one side of the plurality of arrays in the first direction, to one another in the second direction, a third wiring that electrically connects the elements, which are positioned at the other end side of the plurality of element arrays in the first direction, to one another in the second direction, a first connection terminal electrically connected to one end of the second wiring in the second direction, and a second connection terminal electrically connected to the other end of the third wiring in the second direction.

### BACKGROUND OF THE INVENTION

### Field of the Invention

The present invention relates to a capacitor module, a resonator including the capacitor module, and a wireless power transmission device, a wireless power reception device, and a wireless power transmission system, which include the resonator.

Priority is claimed on Japanese Patent Application No. 2017-213478, filed Nov. 6, 2017, the content of which is incorporated herein by reference.

### Description of Related Art

In recent years, a wireless power transmission technology for performing wireless power transmission by using a magnetic field resonance method has received attention. For example, when a battery (a secondary battery) installed in an electrically driven vehicle such as an electric vehicle is charged, it is possible to supply external power in a wireless manner by using the wireless power transmission technology without connection to a charging, cable (called non-contact charging or non-contact power feeding).

Furthermore, in this wireless power transmission technology, a magnetic field resonance method using a resonance phenomenon between two resonators has been actively discussed (for example, see Patent Documents 1 and 2 below). In the magnetic field resonance method, resonators of a power transmission side and a power reception side use a resonance circuit including a coil and a capacitor. In the magnetic field resonance method, resonance frequencies of these two resonators are caused to become close to each other (or to coincide with each other), and high frequency current and voltage near this resonance frequency are applied to the resonator of the power transmission (a primary) side, so that power is transmitted to the electromagnetically resonated resonator of the power reception (a secondary) side in, a wireless manner.

In this magnetic field resonance method, there is an advantage that it is possible to increase a distance between the power transmission side coil and the power reception side coil, as compared with an electromagnetic induction method in which the power transmission side coil and the power reception side coil are electromagnetically coupled to each other by using an, electromagnetic induction principle. Furthermore, in the magnetic field resonance method, since it is possible to transmit power of several kW or more over a distance of about several cm to about several tens of cm in a wireless manner, application to various systems is being explored.

### Patent Documents

[Patent Document 1] Japanese Unexamined Patent Application, First

Publication No. 2017-5790

[Patent Document 2] Japanese Unexamined Patent Application, First Publication No. 2017-51084

[Patent Document 3] Japanese Unexamined Patent Application, First Publication No. 2016-18802

### SUMMARY OF THE INVENTION

However, when wireless power transmission is performed for the aforementioned electric vehicle, large capacity high frequency current and voltage are applied to the resonators of the power transmission side and the power reception side. In order to cope with this, the capacitor constituting the aforementioned resonator uses a capacitor module in which a plurality of chip capacitors (capacitor elements) are disposed and mounted in an array on a principal surface of a printed wiring substrate (for example, see Patent Document 3 above).

Furthermore, the capacitor module has a structure in which a pair of terminal electrodes provided at both ends of each chip capacitor and a pair of pad electrodes provided on the printed wiring substrate are solder-bonded to each other, so that each chip capacitor is mounted on the printed wiring substrate.

However, in the capacitor module disclosed in Patent Document 3 above, allowing a high frequency current (about several tens of kHz) to equally flow through a plurality of chip capacitors disposed in an array on a substrate is not considered. Therefore, when a high frequency current does not equally flow, since the current is concentrated on some chip capacitors, these chip capacitors generate heat and thus may break.

The present invention has been made to solve the aforementioned problems, and an object of the present invention is to provide a capacitor module capable of allowing a current to equally flow through a plurality of capacitor elements mounted on a substrate, a resonator including the capacitor module, and a wireless power transmission device, a wireless power reception device, and a wireless power transmission system, which include the resonator.

A capacitor module according to an aspect of the present invention includes a substrate having a first principal, surface and a second principal surface opposite to each other in a thickness direction, and a capacitor element group including a plurality of capacitor elements mounted on at least the first principal surface of the substrate, wherein the capacitor element group has a plurality of capacitor element arrays in which the plurality of capacitor elements disposed in the first direction of the first direction and the second direction are connected in series to one another, and has a structure in which the plurality of capacitor element arrays disposed in the second direction are connected in parallel to one another, the first direction and the second direction crossing each other in a plane of the substrate, and the substrate has a first wiring that electrically connects the capacitor elements, which are adjacent to one another in the first direction among the plurality of capacitor elements constituting the capacitor element array, to one another, a second wiring that electrically connects the capacitor elements, which are positioned at one end side of the plurality of capacitor element arrays in the first direction, to one another in the second direction, a third wiring that electrically connects the capacitor elements, which are positioned at the other end side of the plurality of capacitor element arrays in the first direction, to one another in the second direction, a first connection terminal electrically connected to one end side of the second wiring in the second direction, and a second connection terminal electrically connected to the other end side of the third wiring in the second direction.

As described above, according to an, aspect of the present invention, it is possible to provide, a capacitor module capable of allowing a current to equally flow through a plurality of capacitor elements mounted on a substrate and a resonator including the capacitor module. Furthermore, it is possible to provide a wireless power transmission device, a wireless power reception device, and a wireless power transmission, system, which include the resonator.

### BRIEF DESCRIPTION OF THE DRAWINGS

FIG. 1 is a configuration diagram illustrating an example of a wireless power transmission system according to an embodiment of the present invention;

FIG. 2 is a circuit diagram illustrating a configuration of a power transmission side resonator and a power reception side resonator of the wireless power transmission system illustrated in FIG. 1;

FIG. 3 is a plan view illustrating a configuration of a capacitor module to which the present invention is applied;

FIG. 4 is an enlarged plan view of main elements of the capacitor module illustrated in FIG. 3;

FIG. 5 is a sectional view of the capacitor module taken along line A-A illustrated in FIG. 4;

FIG. 6 is a plan view illustrating another configuration example of the capacitor module to which the present invention is applied:

FIG. 7 is a plan view illustrating another configuration example of the capacitor module to which the present invention is applied:

FIG. 8 is a plan view illustrating another configuration example of the capacitor module to which the present invention is applied;

FIG. 9A is a plan view illustrating a modification example of a though hole;

FIG. 9B is a plan vie illustrating a modification example of a though hole; and

FIG. 10 is a plan view illustrating a configuration in which a plurality of capacitor element groups are provided in the capacitor module to which the present invention is applied.

### DETAILED DESCRIPTION OF THE INVENTION

Hereinafter, an embodiment of the present invention will be described in detail with reference to the drawings.

In the drawings used for the following description, characteristic parts may be enlarged for the purpose of convenience in order to facilitate the understanding of characteristics, and it is assumed that the dimensional proportions and the like of respective elements may, not be identical to actual dimensions. Furthermore, since materials, dimensions and the like exemplified in the following description are examples, the present invention is not limited thereto and can be embodied through appropriate modification in a range in which the scope of the present invention is not changed.

(Wireless Power Transmission System)

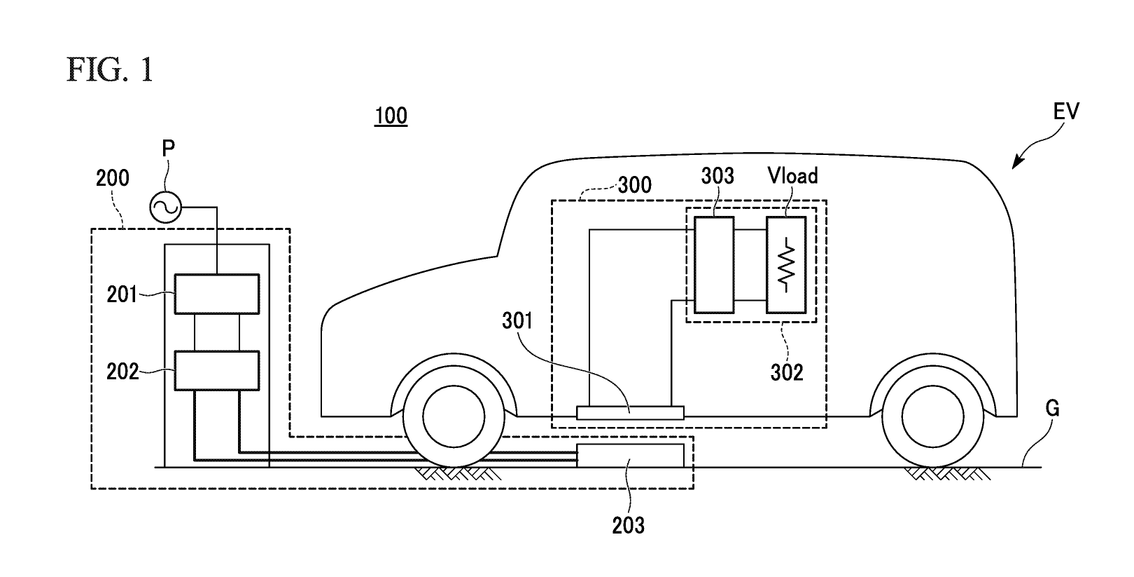

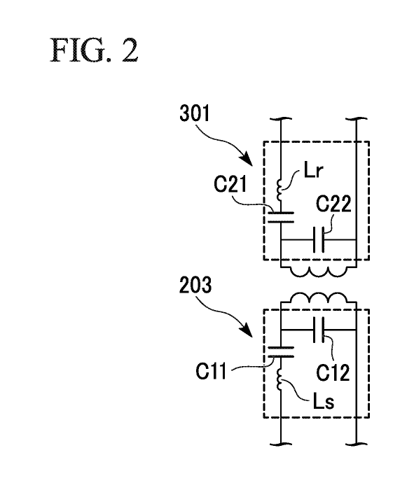

Firstly, as an embodiment of the present invention, a wireless power transmission system 100 illustrated in FIG. 1 and FIG. 2 will be described for example. FIG. 1 is a configuration diagram illustrating an example of the wireless power transmission system 100. FIG. 2 is a circuit diagram illustrating a configuration of a power transmission side resonator 203 and a power reception side resonator 301 of the wireless power transmission system 100.

The wireless power transmission system 100 of the present embodiment is obtained by applying the present invention to a non-contact charging system that performs non-contact charging for a battery (a second battery) installed in an electric vehicle EV as illustrated in FIG. 1 and FIG. 2. The electric vehicle EV is an electrically driven vehicle (a moving, body) that travels when a motor is driven using power charged into the battery.

Specifically, the wireless power transmission system 100 of the present embodiment performs wireless power transmission by using a magnetic field resonance method, and includes a wireless power transmission device (hereinafter, referred to a “power transmission device”) 200 installed on the ground G of a charging equipment side and a wireless power reception device (hereinafter, referred to a “power reception device”) 300 installed in the electric vehicle EV.

The power transmission device 200 generally includes a power supply circuit 201, a driving circuit 202, and the power transmission side resonator 203. On the other hand, the power reception device 300 generally includes the power reception side resonator 301 and a load 302. Furthermore, the load 302 is composed of a rectification circuit 303 and a variable load Vload.

The power supply circuit 201 serves as an AC/DC power supply that is electrically connected to an external commercial power supply P and converts AC power inputted from the commercial power supply P to desired DC power. The power supply circuit 201 is electrically connected to the driving circuit 202. The power supply circuit 201 supplies the converted DC power to the driving circuit 202.

It is sufficient if the power supply circuit 201 outputs DC power to the driving circuit 202, and the configuration of the power supply circuit 201 is not particularly limited. For example, for the power supply circuit 201, there may be a power supply circuit obtained by combining a rectification circuit, which rectifies AC power and converts the rectified AC power to DC power, with a power factor correction (PFC) circuit, which performs power factor improvement, a power supply circuit obtained by combining the same rectification circuit with a switching circuit such as a switching converter, and the like.

The driving circuit 202 converts the DC power supplied from the power supply circuit 201 to high frequency power. For the driving circuit 202, for example, there may be a switching circuit, in which a plurality of switching elements are connected to one another on a bridge basis, and the like. The driving circuit 202 is electrically connected to the power transmission side resonator 203. The driving circuit 202 supplies the power transmission side resonator 203 with high frequency power with a driving frequency controlled on the basis of a resonance frequency of the power transmission side resonator 203.

The power transmission side resonator 203 constitutes an LC resonance circuit including a power transmission side coil L1 and a power transmission side capacitor C1, The resonance frequency of the power transmission side resonator 203 side is caused to become close to the resonance frequency of the power reception side resonator 301 side (or to coincide with the resonance frequency of the power reception side resonator 301 side), so that wireless power transmission using a magnetic field resonance method is possible.

The power transmission side, resonator 203 of the present embodiment has a configuration in which a reactor Ls is serially inserted into the power transmission side capacitor C1. In such a configuration, it is easy to control the imaginary part of an impedance of a wireless power transmission network including the power transmission side resonator 203, the power reception side resonator 301, and the load 302 such that it is positive. Furthermore, the reactor Ls has high impedance with respect to a frequency component sufficiently higher than the resonance frequency of the power transmission side resonator 203 side. In this way, the reactor Ls serves as a filter that supplies the power transmission side coil L1 with power with no high frequency component.

The power transmission side coil L1, for example, is configured by a coil for wireless power transmission in which a Litz wire including copper, aluminum and the like has been spirally wound. The power transmission side coil L1 of the present embodiment is installed on the ground G. or is buried in the ground G to face a lower side of a floor of the electric vehicle EV. In addition, in the present embodiment, the power transmission side coil L1 (the power transmission side resonator 203) is configured to be installed on the ground G together with the power supply circuit 201.

The power transmission side, capacitor C1 has a function of adjusting a driving frequency and both end voltages of the load 302. The power transmission side capacitor C1 of the present embodiment is configured by a first capacitor C11 connected in series to the power transmission side coil L1 and a second capacitor C12 connected to the power transmission side coil L1 in a parallel manner; however, the present invention is not, limited to such a configuration. For example, the power transmission side capacitor C1 may be configured to include only the first capacitor C11 connected in series to the power transmission side coil L1.

The power reception side resonator 301 constitutes an LC resonance circuit including a power reception side coil L2 and a power reception side capacitor C2. The resonance frequency of the power reception side resonator 301 side is caused to become close to the resonance frequency of the power transmission side resonator 203 side (or to coincide with the resonance frequency of the power transmission side resonator 203 side), so that wireless power transmission using the magnetic field resonance method is possible.

The power reception side resonator 301 of the present embodiment has a configuration in which a reactor Lr is serially inserted into the power reception side capacitor C2. In such a configuration, the reactor Lr has high impedance with respect to a frequency component sufficiently higher than the resonance frequency of the power reception side resonator 301 side. In this way, the reactor Lr serves as a filter that supplies the load 302 with power with no high frequency component.

The power reception side coil L2, for example, is configured, by a coil for wireless power transmission in which a Litz wire including copper, aluminum and the like has been spirally wound. The power reception side coil L2 of the present embodiment is installed under the floor of the electric vehicle EV to face the power transmission side coil L1 installed on the ground G or buried in the ground G.

The power reception side capacitor C2 has a function of adjusting a driving frequency and both end voltages of the load 302. The power reception side capacitor C2 of the present embodiment is configured by a third capacitor C21 connected in series to the power reception side coil. L2 and a fourth capacitor. C22 connected to the power reception side coil L2 in a parallel manner; however, the present invention is not limited to such a configuration. For example, the power reception side capacitor C2 may be configured to include only the third capacitor C21 connected in series to the power reception side coil L2.

The rectification circuit 303 is electrically connected to the power reception side resonator 301, rectifies the high frequency power received in the power reception side coil L2, and converts the rectified high frequency power to DC power. For the rectification circuit 303, for example, there may be a half-wave rectification circuit composed of one switching element or a diode and a smoothing capacitor, a full wave rectification circuit composed of four switching elements connected to one another on a bridge basis or a diode and a smoothing capacitor, and the like. The rectification circuit 303 is electrically connected to the variable load Vload. The rectification circuit 303 supplies the converted DC power to the variable load Vload. In the power reception device 300, a charger may be provided between the rectification circuit 303 and the variable load Vload.

The variable load Vload is connected between output terminals of the rectification circuit 303 and stores or consumes the DC power supplied from the rectification circuit 303. For the variable load Vload, there may be a battery, a motor and the like installed in the electric vehicle EV.

The variable load Vload can be regarded as a resistive load in which an equivalent resistance value of the load 302 changes according to the passage of time due to a demand state (a storage state or a consumption state) of power. Since an amount of power consumed in the rectification circuit 303 is sufficiently smaller than that in the variable load Vload, the equivalent resistance value of the load 302 may be regarded as being approximate to an equivalent resistance value of the variable load Vload.

In the wireless power transmission system 100 having the above configuration of the present embodiment, it is possible to transmit power in a wireless manner toward the power reception device 300 from the power transmission device 200 by a magnetic field resonance method using a resonance phenomenon between the power transmission side resonator 203 and the power reception side resonator 301. That is, in the magnetic field resonance method, the resonance frequencies of these two resonators 203 and 301 are caused to become close to each other (or to coincide with each other), and high frequency current and voltage around the resonance frequency are applied to the power transmission side resonator 203, so that power can be transmitted (supplied) to the electromagnetically resonated power reception side resonator 301 in a wireless manner.

Consequently, in the wireless power transmission system 100 of the present embodiment, it is possible to perform non-contact charging for a battery installed in the electric vehicle EV while transmitting power supplied from the charging equipment side to the electric vehicle EV in a wireless manner without connection to a charging cable.

(Capacitor Module)

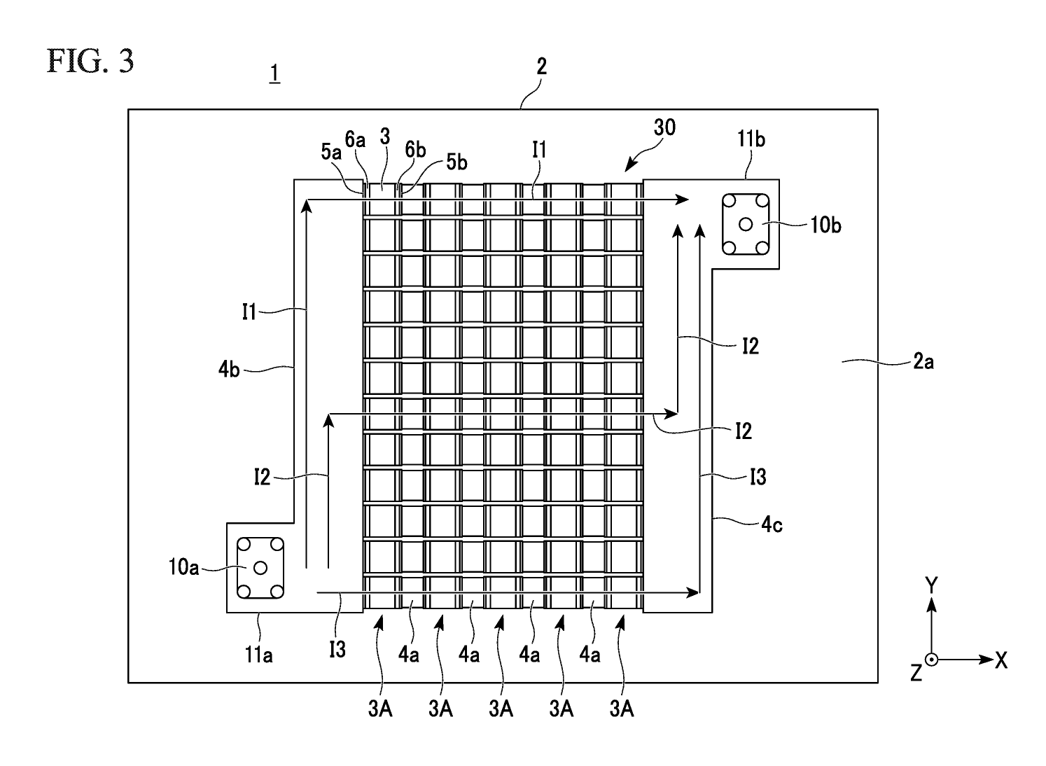

Next, as a capacitor module employing the present invention, a capacitor module 1 illustrated in FIG. 3 to FIG. 6 will be described for example.

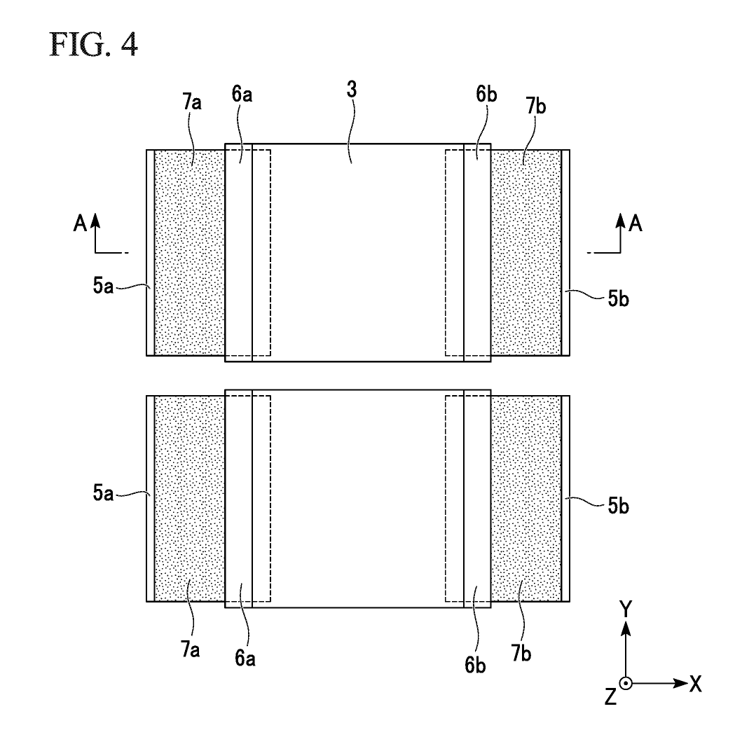

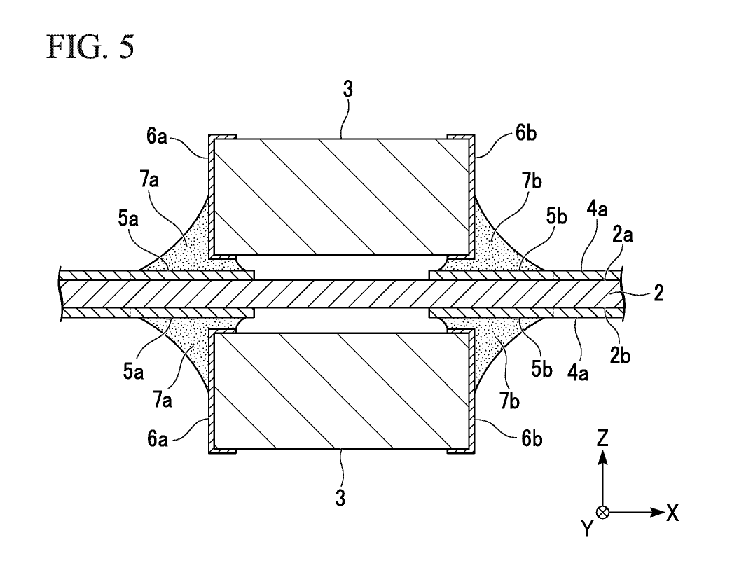

FIG. 3 is a plan view illustrating a configuration of the capacitor module 1. FIG. 4 is an enlarged plan view of main elements of the capacitor module 1. FIG. 5 is a sectional view of the capacitor module 1 taken along line A-A illustrated in FIG. 4.

In the following drawings, it is assumed that a XYZ orthogonal coordinate system is set, an X axis direction is a first direction on a horizontal plane of the capacitor module 1, a Y axis direction is a second direction on the horizontal plane of the capacitor module 1, and a Z axis direction is a thickness direction of the capacitor module 1.

The capacitor module 1 of the present embodiment includes the substrate 2 having a first principal surface 2a and a second principal surface 2b opposite to each other in the thickness direction, and a capacitor element group 30 including a plurality of capacitor elements 3 disposed in an array on at least the first principal surface 2a (both principal surfaces 2a and 2b in the present embodiment) of the substrate 2 as illustrated in FIG. 3 to FIG. 5.

Furthermore, the capacitor module 1 of the present embodiment has a structure in which the plurality of capacitor elements 3 are mounted at overlapping positions on the first principal surface 2a and the second principal surface 2b in the plan, dew. That is, the capacitor module 1 basically has the same mounting structure (a symmetrical structure in which the substrate 2 is interposed between the first principal surface 2a and the second principal surface 2b) at the first principal surface 2a side and the second principal surface 2b side of the substrate 2.

Consequently, in the present embodiment, the mounting structure of the first principal surface (an upper surface) 2a side of the substrate 2 will be described, and unless otherwise specifically mentioned, the mounting structure of the second principal surface (a lower surface) 2b side of the substrate 2 will not be described.

The capacitor element group 30 has a plurality of capacitor element arrays 3A in which the plurality of capacitor elements 3 disposed in the first direction (the X axis direction) of the first direction and the second direction (the Y axis direction) are connected in series to one another, and has a structure in which the plurality of capacitor element arrays 3A disposed in the second direction are connected in parallel to one another, wherein the first direction and the second direction cross each other (are orthogonal to each other in the present embodiment) on the plane of the substrate 2.

The substrate 2 includes a double-sided printed wiring substrate in which a plurality of wiring patterns are provided on both surfaces of an insulating substrate formed in an approximately rectangular flat plate shape as a whole. Specifically, the substrate 2 has a first wiring 4a that electrically connects the capacitor elements 3, which are adjacent to one another in the first direction among the plurality of capacitor elements 3 constituting the capacitor element array 3A, to one another, a second wiring 4b that electrically connects the capacitor elements 3, which are positioned at one end side of the plurality of capacitor element arrays 3A in the first direction, to one another in the second direction, and a third wiring 4c that electrically connects the capacitor elements 3, which are positioned at the other end side of the plurality of capacitor element arrays 3A in the first direction, to one another in the second direction.

Furthermore, at positions of the substrate 2 corresponding to each capacitor element 3, a first pad electrode 5a and a second pad electrode 5b are provided. The first pad electrode 5a and the second pad electrode 5b are obtained by patterning a part of the wirings 4a to 4c called lands in a rectangular shape. The first pad electrode 5a and the second pad electrode 5b have the same shape and are juxtaposed in the first direction.

The capacitor elements 3 include laminated ceramic chip capacitors formed in an approximately rectangular shape in the plan view. Each of the capacitor elements 3 has a first terminal electrode 6a provided along an end edge in a short, direction (the second direction) at one end side in a longitudinal direction (the first direction) thereof, and a second terminal electrode 6b provided along an end edge in the short direction (the second direction) at the other end side in the longitudinal direction (the first direction) thereof.

Each of the capacitor elements 3 constituting the capacitor element group 30 is mounted on the substrate 2 via a first soldered part 7a in which the first terminal electrode 6a and the first pad electrode 5a are solder-bonded to each other, and a second soldered part 7b in which the second terminal electrode 6b and the second pad electrode 5b are solder-bonded to each other. In this way, each of the capacitor elements 3 is mounted on the substrate 2 bridging between the first pad electrode 5a and the second pad electrode 5b.

Meanwhile, the capacitor module 1 of the present embodiment has a first connection terminal 10a electrically connected to one end side of the second wiring 4b in the second direction, and a second connection terminal 10b electrically connected to the other end side of the third wiring 4c in the second direction.

The first connection terminal 10a and the second connection terminal 10b are external connection terminals of the capacitor module 1, and are provided on land parts 11a and 11 b protruding in a rectangular shape outward in the first direction from one end side of the second wiring 4b in the second direction and the other end side of the third wiring 4c in the second direction. In this way, the first connection terminal 10a and the second connection terminal 10b are provided at symmetrical positions (diagonal positions n the present embodiment) while interposing the capacitor element group 30 therebetween in the plane of the substrate 2.

In such a case, between the first connection terminal 10a and the second connection terminal 10b, a current path from one connection terminal (the first connection terminal 10a in the present embodiment) to the other connection terminal (the second connection terminal 10b in the present embodiment) can be equalized among the capacitor element arrays 3A constituting the capacitor element group 30.

That is, a current inputted from the first connection terminal 10a reaches the other end side from one end side of each capacitor element array 3A constituting the capacitor element group 30 via the second wiring 4b, and is outputted to the second connection terminal 10b via the third wiring 4c.

In such a case, among the capacitor element arrays 3A constituting the capacitor element group 30, the length of the current path of a current I1 flowing through the capacitor element array 3A positioned at the other end side in the second direction, the length of the current path of a current I2 flowing through the capacitor element array 3A positioned at the center side in the second direction, and the length of the current path of a current I3 flowing through the capacitor element array 3A positioned at one side in the second direction are identical to one another between the first connection terminal 10a and the second connection terminal 10b.

In this way, in the capacitor module 1 of the present embodiment, the currents I1 to I3 can approximately equally flow through the plurality of capacitor elements 3 mounted on the substrate 2. Consequently, in the capacitor module 1 of the present embodiment, it is possible to suppress generation of heat from each capacitor element 3 while avoiding the probability that the current ill be concentrated on some capacitor elements 3 and these capacitor elements 3 will break.

Furthermore, the capacitor module 1 of the present embodiment has a structure in which the plurality of capacitor elements 3 are mounted at overlapping positions on the first principal surface 2a and the second principal surface 2b in the plan view. In, such a case, it is possible to achieve miniaturization and integration of the capacitor module 1 while suppressing the generation of heat from each capacitor element 3 on both principal surfaces 2a and 2b of the substrate 2.

Furthermore, in the capacitor module 1 of the present embodiment, the first connection terminal 10a and the second connection terminal 10b are provided at diagonal positions while interposing the capacitor element group 30 therebetween in the plane of the substrate 2. In such a case, it is possible, to minimize the length of a current path through which one end side of the second wiring 4b in the second direction and the first connection terminal 10a are electrically connected to each other and the length of a current path through which the other end side of the third wiring 4c in the second direction and the second connection terminal 10b are electrically connected to each other. In this way, it is possible to minimize loss due to wiring patterns.

In addition, the capacitor module 1 of the present embodiment is not limited to the configuration in which the first connection terminal 10a and the second connection terminal 10b are provided at diagonal positions while interposing the capacitor element group 30 therebetween.

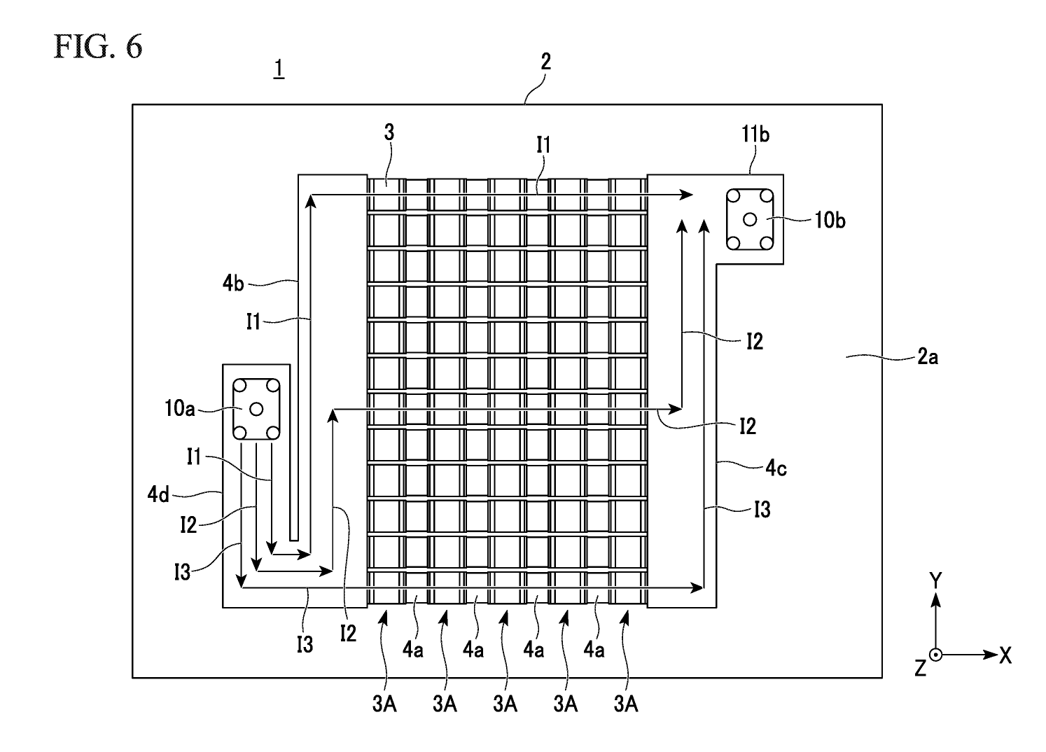

For example, it is also possible to employ a configuration in which as illustrated in FIG. 6 one end side of the second wiring 4b in the second direction and the first connection terminal 10a are electrically connected to each other via a first extension wiring 4d extending from one end side of the second wiring 4b in the second direction to the other end side in the second direction. In the configuration illustrated in FIG. 6, the position of the first connection terminal 10a can be moved around the center of the capacitor element group 30 in the second direction from the diagonal position of the capacitor element group 30 due to the first extension wiring 4d.

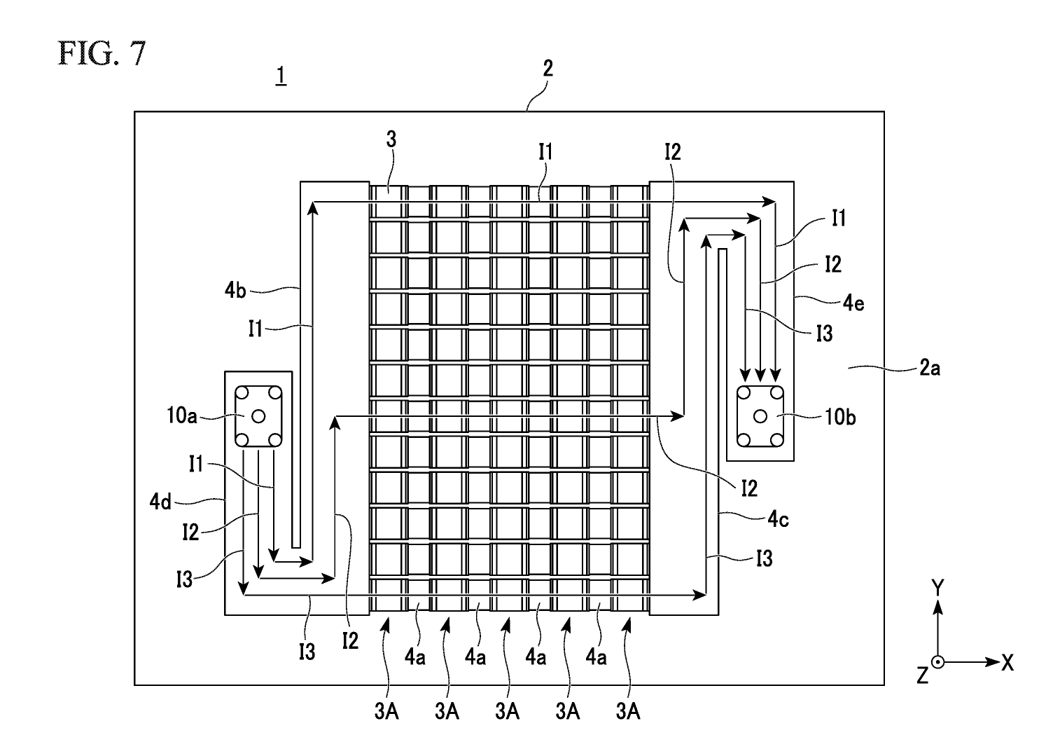

Moreover, it is also possible to employ a configuration in which as illustrated in FIG. 7, the other end side of the third wiring 4c in the second direction and the second connection terminal 10b are electrically connected to each other via a second extension wiring 4e extending from the other end side of the third wiring 4c in the second direction to one end side in the second direction. In the configuration illustrated in FIG. 7, the position of the second connection terminal 10b can be moved around the center of the capacitor element group 30 in the second direction from the diagonal position of the capacitor element group 30 due to the second extension wiring 4e.

In any case, the lengths of current paths from the first connection terminal 10a to the second connection terminal 10b can be equalized among the capacitor element arrays 3A constituting the capacitor element group 30 regardless of the extension length of the first extension wiring 4d or the second extension wiring 4e. Consequently, it is possible to improve the degree of freedom in design of the arrangement of the first connection terminal 10a and the second connection terminal 10b while suppressing the generation of heat from each capacitor element 3.

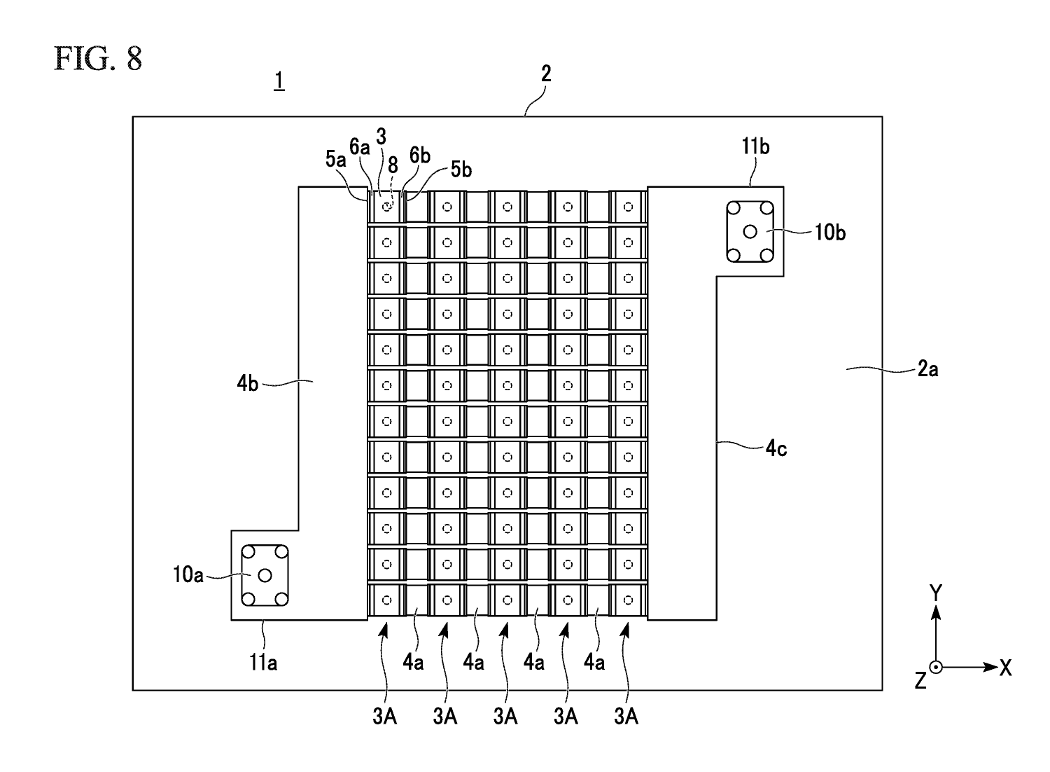

Furthermore, the capacitor module 1 of the present embodiment may have a configuration in which for example, as illustrated in FIG. 8, a plurality of penetrating holes 8 are provided at positions corresponding to the plurality of capacitor elements 3 to pass through the substrate 2 in the thickness direction (the Z axis direction).

The penetrating hole 8 has circular shape in the plan view and is provided between (at the center in the present embodiment) the first pad electrode 5a and the second pad electrode 5b. Also in the configurations illustrated in FIG. 6 and FIG. 7, such a penetrating, hole 8 may be provided in a similar manner.

In the capacitor module 1 of the present embodiment, since such a penetrating, hole 8 is provided, it is possible to reduce creep strain occurring in the first and second soldered parts 7a and 7b. In this way, it is possible to improve a lifespan according to disconnection in the first and second soldered parts 7a and 7b while suppressing the occurrence of solder cracking in the first and second soldered parts 7a and 7b.

In addition, in the capacitor module 1 of the present embodiment, the penetrating hole 8 having a circular shape in, the plan view is formed due to ease of machining of the substrate 2; however, the present invention is not limited to, the shape of the penetrating hole 8 and for example, it is also possible to form the penetrating hole 8 having an oval shape, a long hole shape, other shapes and the like in the plan view. Furthermore, it is also possible to form a plurality of penetrating holes 8 between the first pad electrode 5a and the second, pad electrode 5b.

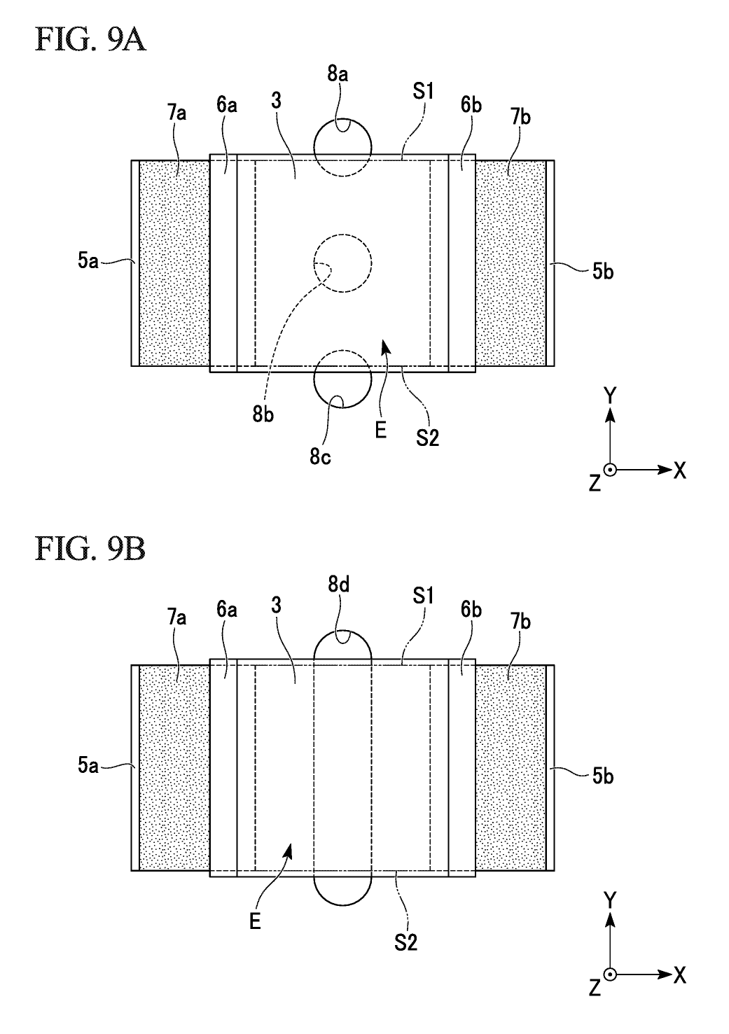

Specifically, as a modification example of the penetrating hole 8, configurations illustrated in FIG. 9A and FIG. 9B can be exemplified. In the configuration illustrated in FIG. 9A, three penetrating holes 8a to 8c are juxtaposed between the first pad electrode 5a and the second pad electrode 5b in the second direction. On the other hand, in the configuration illustrated in FIG. 9B, a penetrating hole 8d having a long hole shape extends in the second direction between the first pad electrode 5a and the second pad electrode 5b.

Furthermore, in the configurations illustrated in FIG. 9A and FIG. 9B, the penetrating holes 8a, 8c, and 8d are provided at positions overlapping the pair of boundary lines S1 and S2 (similarly, the outline of the capacitor element 3) that define a boundary between a region E between the first pad electrode 5a and the second pad electrode 5b and an outside of the region E in the plan view. In such cases, in relation to the creep strain, a point indicating a maximum value exists on the pair of boundary lines S1 and S2 and a crack progresses with this point as a starting point. Consequently, the penetrating holes 8a, 8c, and 8d are provided on the pair of boundary lines S1 and S2, so that it is possible to suppress the occurrence of cracking while reducing the creep strain occurring in the first and second soldered parts 7a and 7b.

The capacitor module 1 of the present embodiment can be preferably used as the power transmission side capacitor C1 and the power reception side capacitor C2 respectively constituting the power transmission side resonator 203 and the power reception side resonator 301. That is, the capacitor module 1 of the present embodiment can constitute the power transmission side capacitor C1 and the power reception side capacitor C2 compatible, with the power transmission side resonator 203 and the power reception side resonator 301 to which large capacity of high frequency current and voltage are applied.

Consequently, in the wireless power transmission system 100 of the present embodiment, it is possible to stably perform wireless power transmission by using the magnetic field resonance method between the power transmission device 200 including such a power transmission side resonator 203 and the power reception device 300 including such a power reception side resonator 301.

It should be understood that the present invention is not limited to the aforementioned embodiment and various modifications can be made without departing from the spirit or scope of the present invention.

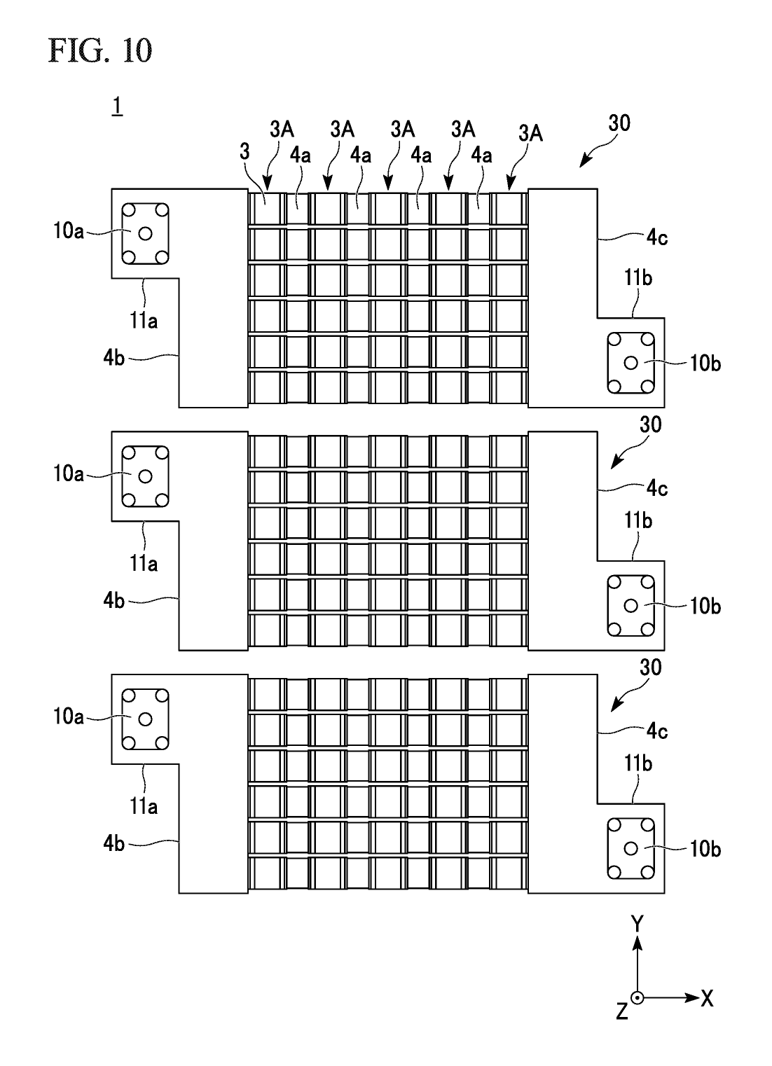

For example, the aforementioned embodiment has a configuration in which one capacitor element group 30 is provided on both principal surfaces 2a and 2b of the substrate 2; however, for example, as illustrated in FIG. 10, it may be possible to employ a configuration in which a plurality of capacitor element groups 30 are provided. In this way, even though the number of capacitor elements 3 to be mounted on the substrate 2 is increased by integration of the capacitor module 1 it is possible to allow a current to equally flow through a plurality of capacitor elements 3 for each capacitor element group 30, so that it is possible to suppress generation of heat from each capacitor element 3.

In addition, the present embodiment has described a case where the present invention is applied to a non-contact charging system that performs non-contact charging for a battery installed in the electric vehicle EV; however, the present invention can also be widely applied to an electrically driven vehicle (a moving body) such as a plug-in hybrid vehicle (PHEV), in addition to the electric vehicle EV.

Furthermore, a power transmission system employing the present invention is not limited to such a non-contact charging system. In addition, for example, the present invention can also be widely applied to a non-contact charging system that performs non-contact charging for, a portable electronic device such as a tablet terminal and a personal computer (PC) placed on a table, a non-contact power feeding system that performs non-contact power feeding for an electrically driven vehicle which is traveling, and the like.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

1 Capacitor module
2 Substrate
2a First principal surface
2b Second principal surface
30 Capacitor element group
3A Capacitor element array
3 Capacitor element
4a First wiring
4b Second wiring
4c Third wiring
4d First extension wiring
4e Second extension wiring
5a First pad electrode
5b Second pad electrode
6a First terminal electrode
6b Second terminal electrode
7a First soldered part
7b Second soldered part
8, 8a to 8d Penetrating, hole
10a First connection terminal
10b Second connection terminal
11a, 11b Land part
100 Wireless power transmission system
200 Wireless power transmission device
201 Power supply circuit
202 Driving circuit
203 Power transmission side resonator
300 Wireless power reception device
301 Power reception side resonator
302 Load
303 Rectification circuit
L1 Power transmission side coil
L2 Power reception side coil
C1 Power transmission side capacitor.
C2 Power reception side capacitor
EV Electric vehicle

What is claimed is:

1. A capacitor module comprising:
a substrate having a first principal surface and a second principal surface opposite to each other in a thickness direction; and
a capacitor element group including a plurality of capacitor elements mounted on at least the first principal surface of the substrate,
wherein the capacitor element group has a plurality of capacitor element arrays in which the plurality of capacitor elements disposed in the first direction of the first direction and the second direction are connected in series to one another, and has a structure in which the plurality of capacitor element arrays disposed in the second direction are connected in parallel to one another, the first direction and the second direction crossing each other in, a plane of the substrate, and
the substrate has a first wiring that electrically connects the capacitor elements, which are adjacent to one another in the first direction among the plurality of capacitor elements constituting the capacitor element array, to one another, a second wiring that electrically connects the capacitor elements, which are positioned at one end side of the plurality of capacitor element arrays in the first direction, to one another in the second direction, a third wiring that electrically connects the capacitor elements, which are positioned at the other end side of the plurality of capacitor element arrays in the first direction, to one another in the second direction, a first connection terminal electrically connected to one end side of the second wiring in the second direction, and a second connection terminal electrically connected to the other end side of the third wiring in the second direction.

2. The capacitor module according to claim 1, wherein the first connection terminal is electrically connected to one end side of the second wiring in the second direction via a first extension wiring extending from one end side of the second wiring in the second direction to the other end, side in the second direction.

3. The capacitor module according to claim 1, wherein the second connection terminal is electrically connected to the other end side of the third wiring in the second direction via a second extension wiring extending from the other end side of the third wiring in the second direction to one end side in the second direction.

4. The capacitor module according to claim 2, wherein the second connection terminal is electrically connected to the other end side of the third wiring in the second direction via a second extension wiring extending from the other end side of the third wiring in the second direction to one end side in the second direction.

5. The capacitor module according to claim 1, wherein the first connection terminal and the second connection terminal are provided at symmetrical positions while interposing the capacitor element group therebetween in the plane of the substrate.

6. The capacitor module according to, claim 2, wherein the first connection terminal and the second connection terminal are provided at symmetrical positions while interposing the capacitor element group therebetween in the plane of the substrate.

7. The capacitor module according to claim 3, wherein the first connection terminal and the second connection terminal are provided at symmetrical positions while interposing the capacitor element group therebetween in the plane of the substrate.

8. The capacitor module according to claim 4, wherein the first connection terminal and the second connection terminal are provided, at symmetrical positions while interposing the capacitor element group therebetween in the plane of the substrate.

9. The capacitor module according to claim 1, wherein the capacitor element group has a structure in which the plurality of capacitor elements are mounted at overlapping positions on the first principal surface and the second principal surface in a plane view.

10. The capacitor module according to claim 2, wherein the capacitor element group has a structure in which the plurality of capacitor elements are mounted at overlapping positions on the first principal surface and the second principal surface in a plane view.

11. The capacitor module according to claim 3, wherein the capacitor element group has a structure in which the plurality of capacitor elements are mounted at overlapping positions on the first principal surface and the second principal surface in a plane view.

12. The capacitor module according to claim 4, wherein the capacitor element group has a structure in which the plurality of capacitor elements are mounted at overlapping positions on the first principal surface and the second principal surface in a plane view.

13. The capacitor module according to claim 5, wherein the capacitor element group has a structure in which the plurality of capacitor elements are mounted at overlapping positions on the first principal surface and the second principal surface in a plane view.

14. The capacitor module according to claim 6, wherein the capacitor element group has a structure in which the plurality of capacitor elements are mounted at overlapping positions on the first principal surface and the second principal surface in a plane view.

15. The capacitor module according to claim 1, wherein the substrate has a first pad electrode solder-bonded to the first terminal electrode provided at one end side of the capacitor element in the first direction and a second pad electrode solder-bonded to the second terminal electrode provided at the other end side of the capacitor element in the first direction.

16. The capacitor module according to claim 15, wherein a penetrating hole is provided between the first pad electrode and the second pad electrode to pass through the substrate in the thickness direction.

17. A resonator including a coil and a capacitor, wherein
the capacitor module according to claim 1 is provided as the capacitor.

18. A wireless power transmission device comprising the resonator according to claim 17.

19. A wireless power reception device comprising the resonator according to claim 17.

20. A wireless power transmission system that performs wireless power transmission to a power reception device from a power transmission device, wherein
at least one of the power transmission device and the power reception device includes the resonator according to claim 17.
